(19) United States
(12) Patent Application Publication
(10) Pub. No.: US 2019/0268566 A1
(43) Pub. Date: Aug. 29, 2019

(54) MERGING AUDIO STREAMS

(71) Applicant: MOTOROLA SOLUTIONS, INC, Chicago, IL (US)

(72) Inventors: ISABEL FIRPO, CHICAGO, IL (US); CATHERINE WITKIN, CHICAGO, IL (US); BENJAMIN ZASLOW, CHICAGO, IL (US)

(21) Appl. No.: 15/906,183

(22) Filed: Feb. 27, 2018

(51) Int. Cl. H04N 7/04; H04N 7/18; H04N 5/265

(52) U.S. Cl. CPC H04N 7/04; H04N 5/265; H04N 7/185

(57) ABSTRACT

A method and apparatus for merging audio streams is provided herein. More particularly, when an officer streams video, the identities of other officers on scene are determined. Audio associated with the other officers is then merged with the video.

### BACKGROUND OF THE INVENTION

With body-worn cameras becoming ubiquitous, public-safety officers sharing and viewing video is becoming more-and-more common. Video shared among officers is typically accomplished by utilizing a broadband over-the-air network, such as a Long-Term-Evolution (LTE) network capable of achieving large data rates, while voice communications take place through a Land Mobile Radio (LMR). Thus, voice communications among public-safety officers typically take place through one network, while video shared among typically take place through another network.

One problem that exists for officers watching video is that the audio associated with the video sometimes doesn't capture all necessary elements. For example, the bodycam video itself may capture officers discussing a situation or incident, but it may be difficult to hear what they are saying. Further, in some instances, an officer streaming video may mute or otherwise cover his or her radio, so that ambient audio from in-frame officers is not captured/caught by the bodycam.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates push-to-talk (PTT) radio.

FIG. 2 is a general operating environment for the present invention.

FIG. 3 is a block diagram of the dispatch center of FIG. 2.

FIG. 4 is a block diagram of the dispatch center of FIG. 2.

FIG. 5 illustrates merging audio.

FIG. 6 is a flow chart showing operation of the dispatch center of FIG. 3 and FIG. 4.

FIG. 7 is a flow chart showing operation of the dispatch center of FIG. 3 and FIG. 4 in accordance with an alternate embodiment of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for merging audio streams is provided herein. More particularly, when an officer streams video, the identities of other officers on scene are determined. Audio associated with the other officers is then merged with the video.

The determination of officers on scene may comprise determining officers assigned a similar computer aided dispatch (CAD) identification (ID). Alternatively, the determination of the officers on scene may comprise determining officers within a predetermined distance of the officer streaming video (e.g., 30 meters). Alternatively, the determination of the officers on scene may comprise determining those officers within a field of view (FOV) of the video being streamed. Therefore, officers “on scene” may be taken from the group consisting of officers assigned a similar CAD ID as the officer streaming the video, officers within the field of view of the camera capturing the video, and officers within a predetermined distance of the officer streaming the video.

The audio associated with an officer may comprise any Push-to-Talk (PTT) communication (transmission and reception) on a talkgroup assigned to an officer. Additionally, the audio associated with an officer may comprise audio associated with video being streamed by, for example, a body-worn camera associated with the officer.

With the above in mind, consider the following example: Officer Smith is streaming video from a body-worn camera. Many public-safety officers may be watching the video (watchers), all of which may be at a different location than officer Smith. Officer Jones and Officer Clarke are on scene, each having a public-safety radio assigned to talkgroup A. Video streamed to the watchers will have communications over talkgroup A embedded within the streamed video. The communications will be embedded at the same location (temporally) in which they occurred at the incident scene.

Consider another example in which Officer Smith is streaming video from a body-worn camera. Many public-safety officers may be watching the video (watchers), all of which may be at a different location than officer Smith. Officer Jones and Officer Clarke are on scene, each having a public-safety radio. Officer Jones is assigned to talkgroup A, while officer Clarke is assigned to talkgroup B. Video streamed to the watchers will have communications over talkgroup A and B embedded within the streamed video. The communications will be embedded at the same location (temporally) in which they occurred at the incident scene.

Consider another example in which Officer Smith is streaming video from a body-worn camera. Many public-safety officers may be watching the video (watchers), all of which may be at a different location than officer Smith. Officer Jones and Officer Clarke are on scene, each having a public-safety radio. Officer Jones is assigned to talkgroup A, while officer Clarke is assigned to talkgroup B. Video streamed to the watchers will have communications over talkgroup A and talkgroup B embedded within the streamed video. The communications will be embedded at the same location (temporally) in which they occurred at the incident scene.

Consider another example in which only officers within the FOV of the streamed video have their associated audio merged with the streamed video. Officer Smith is streaming video from a body-worn camera. Many public-safety officers may be watching the video (watchers), all of which may be at a different location than officer Smith. Officer Jones and Officer Clarke are on scene, each having a public-safety radio. Officer Jones is assigned to talkgroup A, while Officer Clarke is assigned to talkgroup B. Officer Clarke is within the FOV of the streamed video, and Officer Jones is not. Video streamed to the watchers will have communications over talkgroup B embedded in the streamed video. Since Officer Jones is not within the FOV, no merging of talkgroup A with the video will take place, even though officer Jones may be closer to officer Smith than is Officer Clarke.

It should be noted that audio from another body-worn camera (also streaming video) may be merged in a similar manner to merging talkgroup communications. For example, consider a situation in which Officer Smith is streaming video from a body-worn camera. Many public-safety officers may be watching the video (watchers), all of which may be at a different location than officer Smith. Officer Jones and Officer Clarke are on scene, each having a public-safety radio. Officer Jones is assigned to talkgroup A, while officer Clarke is assigned to talkgroup B. Officer Jones is also streaming video from a body-worn camera. Video streamed to the watchers will have communications over talkgroup A and B embedded in the streamed video along with the audio from Officer Jones's streamed video. The communications will be embedded at the same location (temporally) in which they occurred at the incident scene.

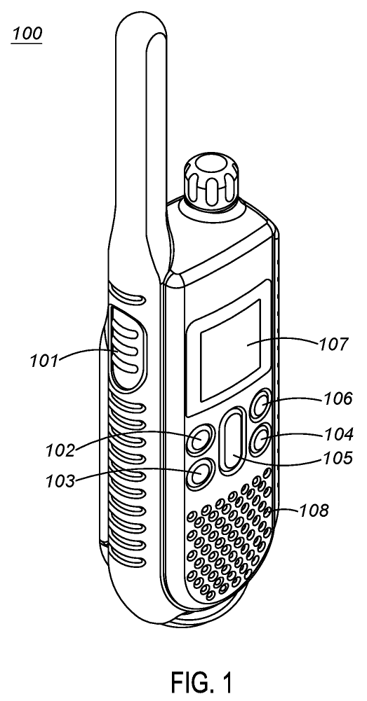

FIG. 1 illustrates push-to-talk (PTT) radio 100. As shown, radio 100 comprises PTT button 101, user interface buttons 102-106, touchscreen 107 (to, for example, view streamed video), and speaker 108. PTT button 101 comprises a standard button, that when pressed, transitions radio 100 from a listening state, to a transmit state. More particularly, a user may initiate a voice transmission by pressing a PTT button on a PTT device. Push-to-talk (PTT) devices are commonly employed by public safety personnel, air traffic controllers, emergency workers, construction site workers, and others who need to be in constant and readily available voice communication. PTT, also known as press-to-transmit, is a method of communicating using half-duplex communication. A PTT button may be pressed to switch a device from a voice reception mode to a transmit-mode. For example, one operator may depress the PTT button on her device and speak into the device's microphone. The speech is converted into an appropriate format and transmitted to one or more other devices over the LMR network, where the operators of those other devices hear the first operator speak through their device's speaker. Audio from a PTT transmission, or from a PTT reception may be embedded within recorded and/or streamed video.

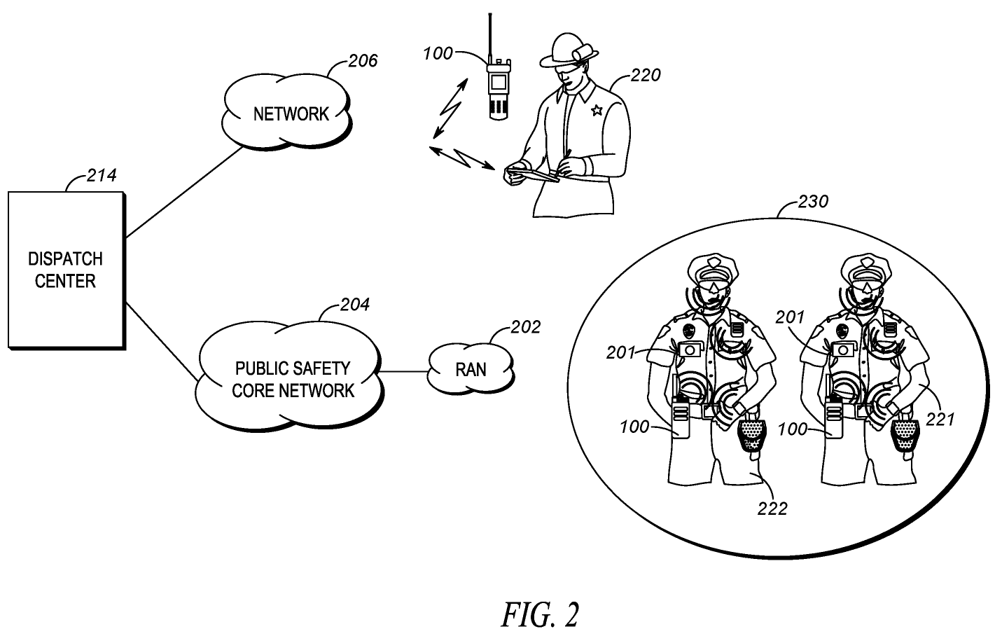

FIG. 2 is a general operating environment for the present invention. The operating environment includes one or more public-safety radio access networks (RANs) 202, a public-safety core network 204, radios 100, broadband network 206, and computer 214. In a preferred embodiment of the present invention, computer 214 serves as a public-safety dispatch center 214.

Communication between dispatch center 214 and device 100 via a first high-speed data link takes place through intervening network 206 such as, but not limited to a cellular communication system or broadband network system. PTT communication between dispatch center 214 and device 100 via a second low-speed (narrowband) link takes place through intervening network 204, such as, but not limited to one employing any number of public-safety protocols. Thus, as shown in FIG. 2, two separate networks exist, namely public-safety core network 204 (e.g., TETRA, P25, . . . , etc.), and wideband network 206 (e.g., LTE, WIFI, Verizon, Sprint, AT&T, . . . , etc.).

Each RAN 202 includes typical RAN elements such as base stations, base station controllers (BSCs), routers, switches, and the like, arranged, connected, and programmed to provide wireless service to user equipment (e.g., device 100) in a manner known to those of skill in the relevant art.

In a similar manner, network 206 includes elements such as base stations, base station controllers (BSCs), routers, switches, and the like, arranged, connected, and programmed to provide wireless high-speed data service to devices (e.g., cameras 201) in a manner known to those of skill in the relevant art.

The public-safety core network 204 may include one or more packet-switched networks and/or one or more circuit-switched networks, and in general provides one or more public-safety agencies with any necessary computing and communication needs, transmitting any necessary public-safety-related data and communications.

Finally, computer 214 is part of a computer-aided-dispatch center, manned by an operator. For example, computer 214 typically comprises a graphical user interface that provides the dispatch operator necessary information about public-safety incidents. Dispatch center 214 also merges audio associated with officers on scene with video received over high-speed network 206. As discussed, the audio associated with the officers may comprise a PTT communication through network 202.

In FIG. 2, a first officer 221 and a second officer 222 are at an incident scene 230. Each officer has an associated body-worn camera 201 that is capable of streaming video (and its associated audio) to dispatch center 214 over network 206. Although on only two officers are shown at scene 230, one will recognize that many officers may be at incident scene 230.

Any video streamed to dispatch center 214 may be accessed by other officers (on scene or not). In FIG. 2, officer 220 is viewing video streamed by officer 222. The streaming occurs by officer 222 sending the streamed video over network 206 to dispatch center 214, and dispatch center forwarding the video to officer 220 over network 206.

Thus, during operation, cameras 201 are capable of sending video via network 206, and radios 100 are capable of sending and/or receiving voice communications via network 204. As one of ordinary skill in the art will recognize, video transmitted from one officer 222 to another officer 220 will take place by uploading the video through network 206 to dispatch center 214, which then transmits the video as part of a downlink transmission to officer 220. (It should be noted that use of the term “video” herein is meant to include any audio associated with the video).

As discussed above, one problem that exists for officers watching video is that the video often doesn't capture all necessary audio. For example, the bodycam video itself may capture officers discussing a situation or incident, but it may be difficult to hear what they are saying. Further, in some instances, an officer streaming video may mute or otherwise cover his or her radio, so that ambient audio from in-frame officers is not captured/caught by the bodycam.

In order to address this issue, when streamed video is received at dispatch center 214, the identities of other officers on scene are determined. Audio associated with the other officers on scene is then merged with the video before sending the video to other officers.

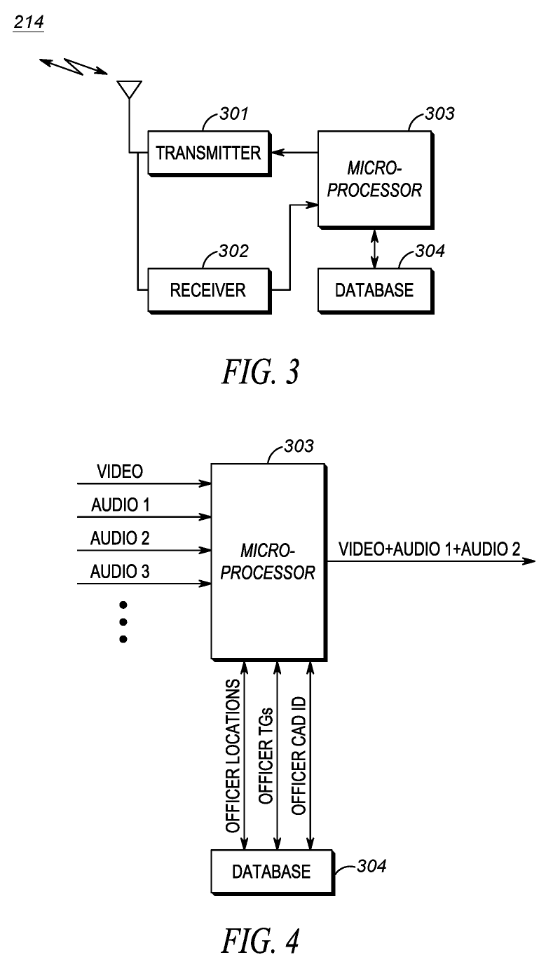

FIG. 3 is a block diagram of dispatch center 214 of FIG. 2. As shown, dispatch center may include transmitter 301, receiver 302, logic circuitry (processor) 303, and database 304.

Transmitter 301 and receiver 302 are configured to operate using well known network protocols. For example, transmitter 301 and receiver 302 may utilize a high-data-rate network protocol when transmitting and receiving video through network 206, and utilize a public-safety protocol when transmitting and receiving voice communications over network 204. In order to accomplish this, transmitter 301 and receiver 302 may contain multiple transmitters and receivers, to support multiple communications protocols simultaneously.

Logic circuitry 303 comprises a digital signal processor (DSP), general purpose microprocessor, a programmable logic device, an Application Processor, or application specific integrated circuit (ASIC) and is utilized to merge audio as discussed above.

Finally, database 304 comprises standard memory (such as RAM, ROM, . . . , etc.) and serves to store officer locations, officer-associated talkgroups (TGs), and/or officer-associated CAD IDs. The definitions of which follow:

Officer Locations—The officer locations preferably comprise a geographic location (e.g., a latitude/longitude).

Officer-Associated TGs—Modern two-way radio systems feature talkgroup creation where it is possible for a radio to be a member of any combination of talkgroups. As a member of a talkgroup, a radio may receive transmissions from, as well as transmit to all members of the talkgroup. Transmission and reception of information to radios outside of an assigned talkgroup is generally not performed. Illustratively, a radio assigned to an ambulance may be a member of a Fire & Rescue talkgroup as well as a Law Enforcement talkgroup. Therefore, the radio may communicate with all members of the Fire & Rescue talkgroup as well as the Law Enforcement talkgroup. An officer-associated talkgroup comprises all talkgroups assigned with the officer's assigned radio.

CAD ID—A computer-aided dispatch (CAD) incident identifier (ID) is utilized to determine a current task assigned to an officer. An incident identification (sometimes referred to as an incident scene identifier, or a CAD incident identifier) is generated for incidents where an officer is dispatched. This ID could be something as simple as a number, or something as complicated as an identification that is a function of populated fields, one of which may comprise an incident type.

The content of database 304 is illustrated in Table 1 shown below:

TABLE 1
Example of data stored in database 304.

| | | | Associated |
|---|---|---|---|
| Officer | Location | CAD ID | Talkgroups |
| Adams | 42° 05′ 09.55N | None Assigned | Police |
| | 88° 18′ 23.61W | | |
| Brady | 42° 05′ 08.36N | 0221 | Police, Fire |
| | 88° 18′ 23.12W | | |
| . . . | . . . | . . . | . . . |
| Zachary | 42° 05′ 51.36N | 0221 | Fire |
| | 88° 18′ 44.19W | | |

During operation of dispatch center 214, a streamed video (and associated audio) is received at receiver 302. In addition, multiple other audio sources may also be received. These other audio sources may comprise communications over various talkgroups, and audio from other received video sources. Logic circuitry 303 receives the streamed video and combines various other audio sources as described above. The video along with the merged audio is then sent to transmitter 301 and transmitted to officers viewing the video. The video with the merged audio may also be stored in database 304, or sent via a wired network (not shown) to other viewers. This is illustrated in FIG. 4.

As shown in FIG. 4, logic circuitry 303 receives the streamed video from a first officer along with three other audio sources (Audio 1, Audio 2, and Audio 3). Logic circuitry 303 accesses database 304 to determine Officers at a same location as the first officer, their talkgroups, and/or their CAD ID assigned to them. Logic circuitry 303 then merges the streamed video along with Audio 1 and Audio 2. (Note that in this example, Audio 3 is not merged). The video with the merged audio is then output.

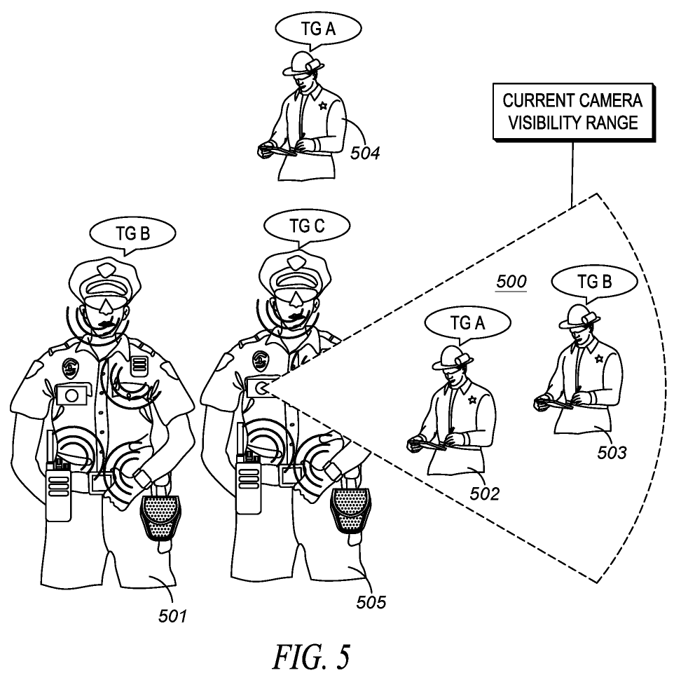

As discussed above, the decision on what audio sources to merge with the received video can be based on CAD ID, Officer-associated talkgroups, Officer locations, and whether or not an officer is in a field of view of the video. This is illustrated in FIG. 5.

FIG. 5 shows five officers at an incident scene, with officer 505 currently streaming video. Each officer 501-505 is assigned a radio and at least one associated talkgroup. As is evident, Officer 505 is assigned to talkgroup C, Officers 502 and 504 are assigned to talkgroup A, and Officers 501 and 503 are assigned to talkgroup B. Currently, only officers 502 and 503 are within the FOV 500 of the streamed video.

All Officers on Scene will have their Audio Merged

In one embodiment, only officers on scene will have their audio merged by logic circuitry 303. Since officers 502-505 are on scene, only audio streams associated with these officers (e.g., any audio received or sent on TG A, TG B, and TG C), will be merged with the streamed video.

In order to determine who is on scene, logic circuitry 303 can access database 304 and determine location information of officers. Only those officers within a predetermined distance from officer 505 will have their audios merged. In another embodiment of the present invention, logic circuitry 303 will access database 304 and determine CAD IDs for officer 505 (streaming) and merge all audio streams for officers having a similar CAD ID. Since it can be assumed that officers having a similar CAD ID will all be at the same incident scene, the CAD ID can be used to determine those officers on scene.

Only Officers within a Camera FOV have their Audio Merged

In one embodiment, only officers within a camera FOV will have their audio merged by logic circuitry 303 even though other officers may be closer to officer 505. With reference to FIG. 5, since officers 502 and 503 are within the camera FOV, only audio streams associated with these officers (e.g., any audio received on TG A and TG B) will be merged with the streamed video. It should be noted that Officer 501 may be the closest individual to officer 505, yet since officer 501 is not within the FOV of the camera, audio associated with officer 501 will not be merged.

In order to determine who is in the FOV, logic circuitry 303 may use computer vision or video analytics visually identify the officer, and identify associated or assigned devices and associated talk group(s).

With the above in mind, FIG. 3 and FIG. 4 provide for an apparatus comprising a receiver 302 configured to receive a first video stream from a first person, logic circuitry 303 configured to determine a second person is in proximity to the first person, determine a talkgroup associated with the second person, and merge audio associated with the talkgroup with the first video stream. A transmitter 301 is provided that is configured to transmit the first video stream with the merged audio.

As discussed above receiver 302 is also configured to receive the first video stream over a first network (e.g., broadband network 206) and receive audio associated with the talkgroup over a second network (e.g., narrowband network 204, which may comprise a public-safety network).

As discussed above, logic circuitry 303 determines the second person is in proximity to the first person by determining that the first and the second persons share a same Computer Aided Dispatch Identification (CAD ID). In an alternate embodiment, logic circuitry 303 determines the second person is in proximity to the first person by determining that the first and the second persons share a same location or are within a predetermined distance from each other. In yet a further embodiment, logic circuitry 303 determines the second person is in proximity to the first person by determining that the second person is within a Field of View (FoV) of a camera streaming the video.

In addition to merging talkgroups, logic circuitry 303 is also configured to merge audio associated with a second video stream received from the second person (i.e., a camera associated with the second person). Both the first and the second video streams may comprise video streams taken from a body-worn camera.

When receiving and merging body-worn-camera video, dispatch center 214 provides for an apparatus comprising a receiver configured to receive a first body-worn-camera video stream from a first body-worn camera worn by a first person and receive a second body-worn-camera video stream from a second body-worn camera worn by a second person. Logic circuitry configured to determine the second person is in proximity to the first person, and merge audio associated with the second body-worn-camera video stream with the first body-worn-camera video stream when it is determined that the second person is in proximity to the first person. A transmitter is provided and configured to transmit the first body-worn camera video stream with the merged audio.

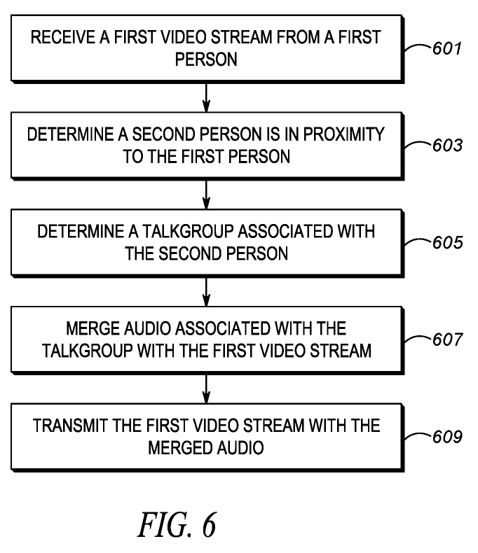

FIG. 6 is a flow chart showing operation of dispatch center 214. It should be noted that the functionality described herein may take place at other network entities besides dispatch center 214 without varying from the scope of the invention. The logic flow begins at step 601 where receiver 203 receives a first video stream from a first person. At step 603, logic circuitry 303 determines that a second person is in proximity to the first person. Logic circuitry 303 then determines a talkgroup associated with the second person (step 605), and merges audio associated with the talkgroup with the first video stream (step 607). Finally, at step 609, transmitter 301 receives the video and merged audio from logic circuitry 303 and transmits the first video stream with the merged audio.

As discussed above, the first video stream is received over a first network; and audio associated with the talkgroup is received over a second network. The first network may comprise a broadband network, and the second network may comprise a narrowband public-safety network.

As discussed above, the step of determining the second person is in proximity to the first person may comprise the step of determining that the first and the second person share a same Computer Aided Dispatch Identification (CAD ID). This information is obtained from database 304. In an alternate embodiment of the present invention the step of determining the second person is in proximity to the first person comprises the step of determining that the first and the second person share a same location or are within a predetermined distance from each other. Again, this information may be obtained from database 304. In yet another embodiment of the present invention the step of determining the second person is in proximity to the first person comprises the step of determining that the second person is within a Field of View (FoV) of a camera streaming the first video.

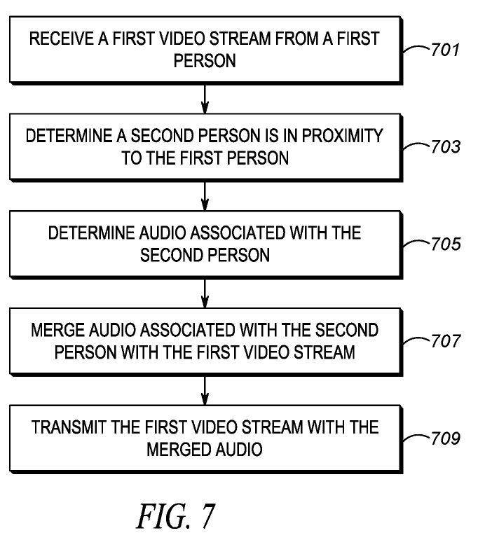

FIG. 7 is a flow chart showing operation of dispatch center 214. It should be noted that the functionality described herein may take place at other network entities besides dispatch center 214 without varying from the scope of the invention. The logic flow begins at step 701 where receiver 203 receives a first video stream from a first person. At step 703, logic circuitry 303 determines that a second person is in proximity to the first person. Logic circuitry 303 then determines audio associated with the second person (step 705), and merges audio associated with the second person with the first video stream (step 707). Finally, at step 709, transmitter 301 receives the video and merged audio from logic circuitry 303 and transmits the first video stream with the merged audio.

As discussed above, the audio associated with the second person may comprise audio associated with a received second video stream from the second person.

Although not addressed in detail, logic circuitry 303 periodically receives location updates for all public-safety radios (via receiver 302) and updates database 304 accordingly. As one of ordinary skill in the art will recognize, the periodic location updates are part of normal messaging between dispatch center 214 and any public-safety radio.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein.

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
a receiver configured to receive a first video stream from a first person;
logic circuitry configured to:
determine a second person is in proximity to the first person;
determine a talkgroup associated with the second person;
merge audio associated with the talkgroup with the first video stream;
a transmitter configured to transmit the first video stream with the merged audio.

2. The apparatus of claim 1 wherein the receiver is also configured to:
receive the first video stream over a first network; and
receive audio associated with the talkgroup over a second network.

3. The apparatus of claim 2 wherein the first network is a broadband network, and the second network is a narrowband public-safety network.

4. The apparatus of claim 1 wherein the logic circuitry determines the second person is in proximity to the first person by determining that the first and the second persons share a same Computer Aided Dispatch Identification (CAD ID).

5. The apparatus of claim 1 wherein the logic circuitry determines the second person is in proximity to the first person by determining that the first and the second persons share a same location or are within a predetermined distance from each other.

6. The apparatus of claim 1 wherein the logic circuitry determines the second person is in proximity to the first person by determining that the second person is within a Field of View (FoV) of a camera streaming the video.

7. The apparatus of claim 1 wherein the logic circuitry is also configured to merge audio associated with a second video stream received from the second person.

8. The apparatus of claim 1 wherein the first video stream from the first person comprises a video stream from a body-worn camera.

9. A method comprising the steps of:
receiving a first video stream from a first person;
determining a second person is in proximity to the first person;
determining a talkgroup associated with the second person;
merging audio associated with the talkgroup with the first video stream;
transmitting the first video stream with the merged audio.

10. The method of claim 9 wherein the first video stream is received over a first network; and audio associated with the talkgroup is received over a second network.

11. The method of claim 10 wherein the first network is a broadband network, and the second network is a narrowband public-safety network.

12. The method of claim 9 wherein the step of determining the second person is in proximity to the first person comprises the step of determining that the first and the second person share a same Computer Aided Dispatch Identification (CAD ID).

13. The method of claim 9 wherein the step of determining the second person is in proximity to the first person comprises the step of determining that the first and the second person share a same location or are within a predetermined distance from each other.

14. The method of claim 9 wherein the step of determining the second person is in proximity to the first person comprises the step of determining that the second person is within a Field of View (FoV) of a camera streaming the first video.

15. The method of claim 9 further comprising the step of merging audio associated with a second video being streamed by the second person.

16. The method of claim 9 wherein the first video stream from the first person comprises a video stream from a body-worn camera.

17. An apparatus comprising:
a receiver configured to receive a first body-worn-camera video stream from a first body-worn camera worn by a first person and receive a second body-worn-camera video stream from a second body-worn camera worn by a second person;
logic circuitry configured to:
determine the second person is in proximity to the first person;
merge audio associated with the second body-worn-camera video stream with the first body-worn-camera video stream when it is determined that the second person is in proximity to the first person;
a transmitter configured to transmit the first body-worn camera video stream with the merged audio.

18. The apparatus of claim 17 wherein the logic circuitry determines the second person is in proximity to the first person by determining that the first and the second person share a same Computer Aided Dispatch Identification (CAD ID).

19. The apparatus of claim 17 wherein the logic circuitry determines the second person is in proximity to the first person by determining that the first and the second person share a same location or are within a predetermined distance from each other.

20. The apparatus of claim 17 wherein the logic circuitry determines the second person is in proximity to the first person by determining that the second person is within a Field of View (FoV) of the first body-worn-camera.
